(19) United States
(12) Patent Application Publication
(10) Pub. No.: US 2007/0162633 A1
(43) Pub. Date: Jul. 12, 2007

(54) Computer peripheral device containing contents and method of outputting contents using the same

(76) Inventors: Chul-Yong Joung, Yongin-si (KR); Bang-Won LEE, Yongin-si (KR); Young-Ho Shin, Yongin-si (KR)

Correspondence Address: CANTOR COLBURN, LLP, 55 GRIFFIN ROAD SOUTH, BLOOMFIELD, CT, 06002, US

(21) Appl. No.: 11/491,796

(22) Filed: Jul. 24, 2006

(30) Foreign Application Priority Data
Nov. 29, 2005 (KR) 10-2005-0114989

(51) Int. Cl. G06F 3/00

(52) U.S. Cl. 710/15

(57) ABSTRACT

A computer peripheral device containing contents and a method of outputting contents using the device are provided. The computer peripheral device containing contents includes: a memory in which contents and a program for driving the contents are previously stored, the memory outputting the contents and the content driving program in a content mode; an operation unit for performing a basic function of the computer peripheral device in a basic function mode; a controller setting the peripheral device to the content mode when a basic function of the peripheral device is initially performed on or after supply of power to execute the content driving program in a connected computer, and receiving a mode conversion signal generated on completion of the content driving program to switch from the content mode to the basic function mode for operation of the operation unit; and an interface for converting a signal output from the controller in a manner designated by the connected computer to output the converted signal. The computer peripheral device containing contents in accordance with the present invention can enhance the effect of contents such as advertisements etc. by outputting the contents when power is supplied to the computer to operate the peripheral device in the basic function mode or when no signal is input to the computer for more than a predetermined time.

### CROSS-REFERENCE TO RELATED APPLICATION

This application claims the benefit of Korean Patent Application No. 10-2005-0114989, filed Nov. 29, 2005, the disclosure of which is hereby incorporated herein by reference in its entirety.

### BACKGROUND OF THE INVENTION

1. Field of the Invention

The present invention relates to a computer peripheral device containing contents and a method of outputting contents using the computer peripheral device, and more particularly, to a computer peripheral device provided with a content memory containing contents and a method of outputting contents using the computer peripheral device.

2. Description of the Related Art

Generally, there are various types of computer peripheral devices, including input devices, e.g., a keyboard, a mouse, and so on, output devices, e.g., a monitor, a speaker, and so on, and handheld storage devices, e.g., a flash memory, and so on. A basic structure of a computer peripheral device 10 is shown in FIG. 1.

An operation unit 11 can perform various operations depending on a function of the computer peripheral device 10. When the computer peripheral device 10 is an input device such as a keyboard, a mouse, or the like, an input signal is generated corresponding to an input applied from the exterior and transmitted to a controller 12. When the computer peripheral device 10 is an output device such as a monitor, a speaker, or the like, an output signal is applied from the controller 12 and output in a designated manner. In addition, when the computer peripheral device 10 is a handheld storage device, a control signal is applied from the controller 12 to store or output data.

Depending on a function of the computer peripheral device 10, the controller 12 converts the input signal to be recognizable by a computer and outputs it, transfers the output signal to be output through the operation unit 11, or applies the control signal to control the operation unit 11.

An interface 13 converts the input signal converted by the controller 12 in a designated manner and transmits it to the computer 20.

The conventional computer peripheral device utilized only the basic function, or the conventional computer peripheral device was used for content purpose. When the conventional computer peripheral device was used for content purpose, a content execution program was provided with a storage medium separate form the peripheral device.

However, when the content execution program was provided separately from the peripheral device, user can set so that the content program is not installed or so that the content program is installed and then the program is not executed. As a result, the effect of the contents cannot be obtained. Here, the contents can be, but not limited to, special purpose program for copy protection, access control, device logo, and so on.

### SUMMARY OF THE INVENTION

The present invention provides a computer peripheral device containing contents that is capable of enhancing an effect of contents by executing contents without fail.

The present invention also provides a method of outputting contents using a computer peripheral device including contents that is capable of enhancing an effect of contents by executing contents without fail.

According to an aspect of the present invention, there is provided a computer peripheral device containing contents, the device comprising: a memory in which contents and a program for driving the contents are previously stored, the memory outputting the contents and the content driving program in a content mode; an operation unit for performing a basic function of the computer peripheral device in a basic function mode; a controller setting the peripheral device to the content mode when a basic function of the peripheral device is initially performed on or after supply of power to execute the content driving program in a connected computer, and receiving a mode conversion signal generated on completion of the content driving program to switch from the content mode to the basic function mode for operation of the operation unit; and an interface for converting a signal output from the controller in a manner designated by the connected computer to output the converted signal.

The operation unit may generate an input signal in response to an input applied from the exterior to output the input signal to the controller when the computer peripheral device is an input device, receive an output signal from the controller to output the output signal in a designated manner when the computer peripheral device is an output device, and store data in response to a control signal applied from the controller or output the stored data when the computer peripheral device is a storage device.

The controller may include a mode setter for selecting one of the content mode and the basic function mode in response to a mode selection signal; and a control device outputting the mode selection signal to the mode setter in response to the mode conversion signal when a basic function of the peripheral device is initially performed on or after supply of power, determining whether a newer version of the content driving program stored in the memory is available at a designated Internet website when the computer is connected to the Internet and storing the newer version when available, installing the newer-version content driving program in the content memory when the content driving program is not installed or when an older version of the content driving program is installed, and executing the content driving program.

The controller may be switched to the content mode to execute the content driving program in the computer when an input of a user is not detected by the computer for more than a predetermined time in the basic function mode, and instantly switched to the basic function mode when an input of a user is detected by the computer.

The control device may block, or partially block, input to all peripheral devices connected to the computer before performing the content driving program in order to prevent interruption of the content driving program by a user when the peripheral device is initially used in the basic function mode on or after the supply of power, and cease the input blocking when the content driving program is completed.

The control device may not be switched to the basic function mode when the content driving program is interrupted by a user before normal completion, in the case of the peripheral device being set to the content mode on operation of the initial basic function on or after the supply of power.

According to another aspect of the present invention, there is provided a computer peripheral device containing contents, the device comprising: a memory in which a content screen saver is previously stored, the memory outputting the content screensaver in a content mode; an operation unit for performing a basic function of the computer peripheral device in a basic function mode; a controller setting the peripheral device to the content mode when a basic function of the peripheral device is initially performed on or after supply of power to determine whether the content screensaver is installed in a connected computer, installing the content screensaver in the memory when the screensaver is not installed, converting a preexisting screensaver set in the computer into the content screensaver, and receiving a content screensaver installation termination signal from the computer to switch from the content mode to the basic function mode for operation of the operation unit; and an interface for converting a signal output from the controller in a manner designated by the connected computer to output the converted signal.

According to still another aspect of the present invention, there is provided a content output method using a computer peripheral device containing contents, the method comprising: a) a content mode step of determining whether the peripheral device is connected to a computer when the peripheral device is initially operated in a basic function mode on or after supply of power to terminate the basic function mode when the peripheral device is not connected to the computer, and set the peripheral device to a content mode when the peripheral device is connected to the computer; b) an upgrade step of determining whether a newer version of a content driving program previously stored in a memory is available on the Internet when the computer is connected to the Internet and downloading and storing the newer version in the memory when available; c) a program installation step of determining whether the new-version content driving program stored in the memory is installed in the computer and installing the new-version content driving program when no content driving program is installed or when the installed content driving program is an older version than the content driving program stored in the memory; d) a first content output step of executing the content driving program to output the contents when the content driving program is installed; and e) a basic function mode step of setting the computer peripheral device to the basic function mode to perform a basic function.

### BRIEF DESCRIPTION OF THE DRAWINGS

The foregoing and other objects, features and advantages of the invention will be apparent from the more particular description of a preferred embodiment of the invention, as illustrated in the accompanying drawing. The drawing is not necessarily to scale, emphasis instead being placed upon illustrating the principles of the invention.

FIG. 1 is a block diagram of a conventional computer peripheral device;

FIG. 2 is a block diagram of a first exemplary embodiment of a computer peripheral device containing contents in accordance with the present invention;

FIG. 3 is a block diagram of an optical mouse containing contents in accordance with the present invention;

FIG. 4 is a block diagram of a handheld memory device containing contents in accordance with the present invention;

FIG. 5 is a block diagram of a second exemplary embodiment of a computer peripheral device containing contents in accordance with the present invention;

FIG. 6 is a flowchart showing a first exemplary embodiment of a content output method using a computer peripheral device containing contents;

FIGS. 7A and 7B are flowcharts showing execution of a content driving program of FIG. 6; and

FIG. 8 is a flowchart showing a second exemplary embodiment of a content output method using a computer peripheral device containing contents.

### DETAILED DESCRIPTION

The present invention will now be described more fully hereinafter with reference to the accompanying drawings, in which exemplary embodiments of the invention are shown. In the drawings, the thickness of the layers and regions are exaggerated for clarity.

Recently, prices of various computer peripheral devices, as well as computer memory, have been rapidly falling due to ongoing technological development. Due to inexpensive pricing, various computer peripheral devices can be used to utilize contents. Also, due to popularization of a universal serial bus (USB) interface, a variety of information that cannot be provided through conventional interfaces of the peripheral devices can be transmitted through the peripheral devices to enable additional functions in addition to the basic functions of the peripheral devices.

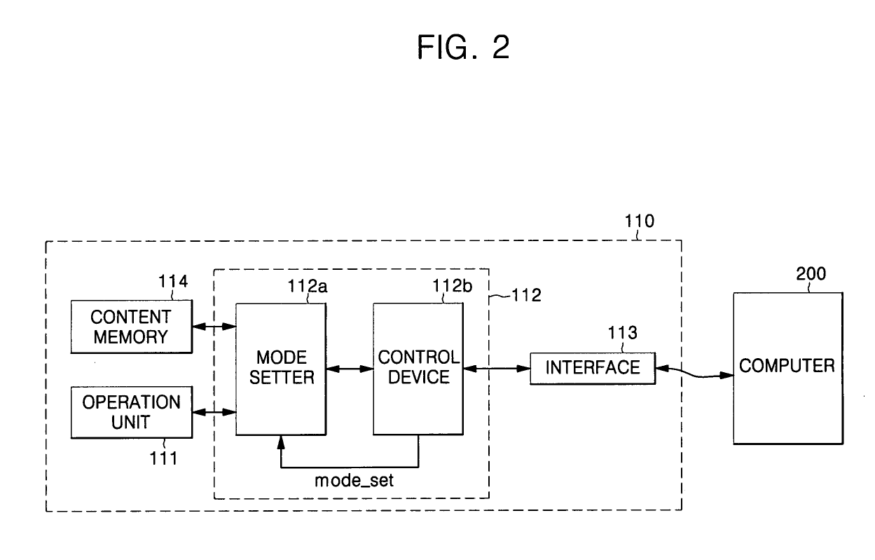

FIG. 2 is a block diagram of a first exemplary embodiment of a computer peripheral device containing contents in accordance with the present invention.

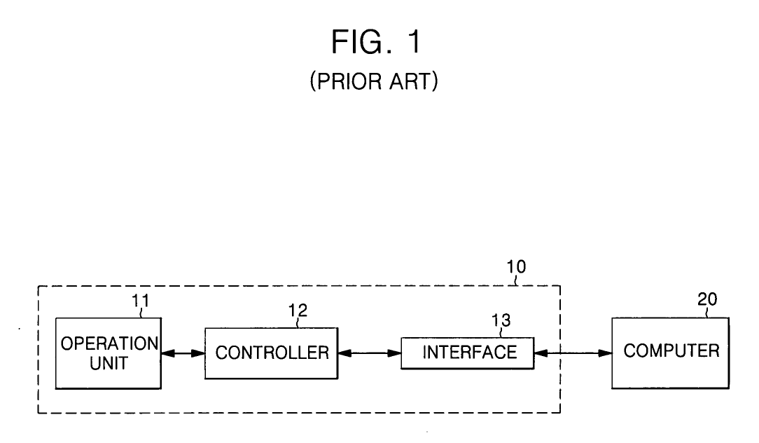

Referring to FIG. 2, in a computer peripheral device 110 containing contents, an operation unit 111 may perform various operations, like the operation unit 11 in FIG. 1.

The contents and a content driving program for driving the contents are stored in a content memory 114, the content memory 114 may be formed of a readable/writable flash memory so as to enable the memory upgrading.

A controller 112 is comprised of a mode setter 112a and a control device 112b. The mode setter 112a receives a mode selection signal mode_set from the control device 112b to set the controller to a content mode of selecting the content driving program stored in the memory 114, or a basic function mode of, according to a function of the peripheral device, receiving an input signal generated from the operation unit 111, outputting an output signal to the operation unit 111, or inputting/outputting a control signal to the operation unit 111.

The control device 112b outputs the mode selection signal mode_set for setting the mode setter 112a to the content mode when the peripheral device is initially operated in the basic function mode on or after supply of power, i.e., when power is supplied to a connected computer to initially operate the peripheral device 110 or when the peripheral device 110 is connected to the computer.

Also, the control device 112b determines whether the computer 200 is connected to the Internet. When the computer 200 is connected to the Internet, the control device 112b determines whether a content driving program from a designated Internet website is a newer version than the content driving program stored in the memory 114, deletes the content driving program stored in the memory 114 when a newer version is available from the designated Internet website, and performs an upgrade operation for storing the newer version of the content driving program.

In addition, the control device 112b determines whether the content driving program is installed in the computer 200, installs the content driving program in the content memory 114 when the program is not installed or when an older version is installed, and executes the content driving program.

The control device 112b receives a mode conversion order issued by the computer 200 on termination of the content driving program to output the mode selection signal mode_set for switching from the content mode to the basic function mode.

In this process, the control device 112b blocks completely or partially input to the computer 200 by a user before execution of the content driving program to prevent the content driving program from being terminated by the user, and stops the input blocking when the execution of the content driving program is finished.

In addition, the control device 112b prevents the computer peripheral device 110 from being switched to the basic function mode when the content driving program is abnormally terminated before completion. Here, the control device 112b uses a method of continuously performing the content driving program.

The interface 113 performs the same function as the interface 12 in FIG. 1. That is, it converts a signal output from the controller 112 in a manner designated by the computer 200 to output the converted signal.

In addition, the computer peripheral device 110 containing contents and a content driving program for driving the contents executes the content driving program in the computer 200 when an input signal is not generated in the computer 200 by a user for more than a predetermined time while the peripheral device is set to the basic function mode, and instantly stops the content driving program when the input signal is generated in the computer 200, thereby preventing user inconvenience.

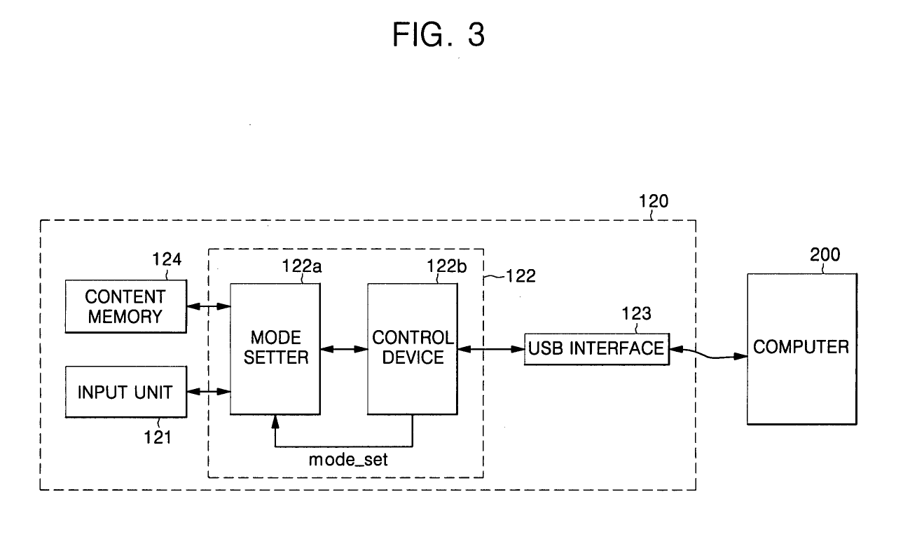

FIG. 3 is a block diagram of an optical mouse containing contents in accordance with the present invention.

Describing an optical mouse 120 containing contents of FIG. 3 with reference to FIG. 2, contents and a content driving program are stored in a content memory 124.

An input unit 121 serving as the operation unit 111 in FIG. 2 receives light emitted therefrom and reflected back to generate an image signal as an input signal of the optical mouse 120 and transmits the image signal to a mode setter 122a.

A control device 122b transmits a mode selection signal mode_set to the mode setter 122a to select the content mode to output contents from a content memory 124, and selects the basic function mode to output the input signal from the input unit 121.

The control device 122b blocks completely or partially input of a user before executing the content driving program in the computer 200 to prevent the content driving program from being terminated by the user, and stops the input blocking when-the content driving program is finished. If computer has no other input unit except the input unit 121, then other input than basic functions of the input unit 121, for example of X-Y cursor movement, can be blocked. If computer has another input unit, for example of touch pad, then all input of the input unit 121 can be blocked.

A USB interface 123 serving as the interface 113 in FIG. 2 converts a signal output from the controller 122 to output the signal.

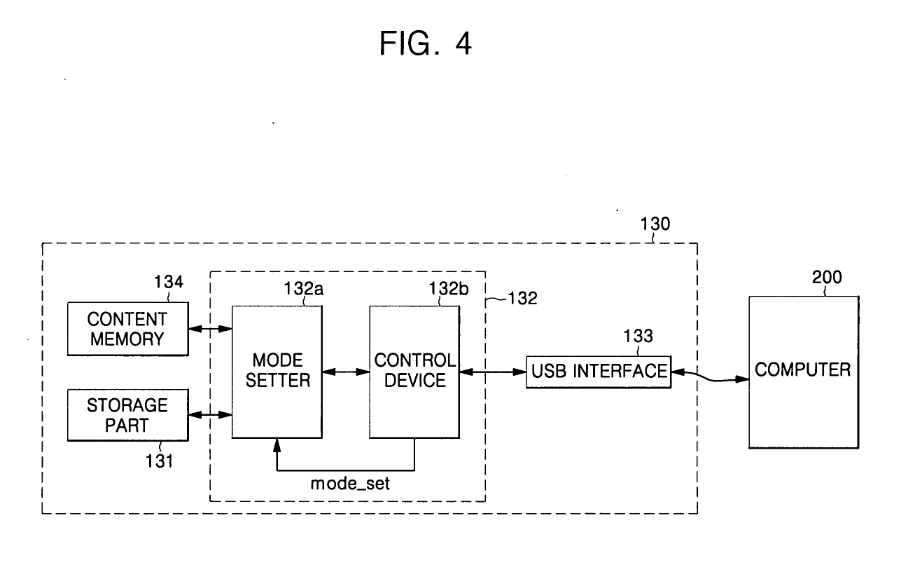

FIG. 4 is a block diagram of a handheld memory device containing contents in accordance with the present invention.

A handheld memory device 130 uses a portion of its preexisting entire memory capacity as a content memory 134 for storing contents and a content driving program, without a separate memory. In order to prevent the content memory 134 from being erased by a user, a control device 132b is set such that the content memory 134 is erased or written to only when the contents or the content driving program are upgraded.

A storage part 131 is another portion of the preexisting entire memory capacity that stores data applied from a controller 132 in response to the control signal of the control device 132b, and outputs the stored data to the controller 132.

The control device 132b prevents the handheld memory device from being operated by a user by blocking access to the storage part 131 of the user when the user terminates the content driving program, and enables use of the handheld memory device 130 by allowing the user to access the storage part 131 when the content driving program is finished.

A USB interface 133 is similar to the USB interface 123 in FIG. 3.

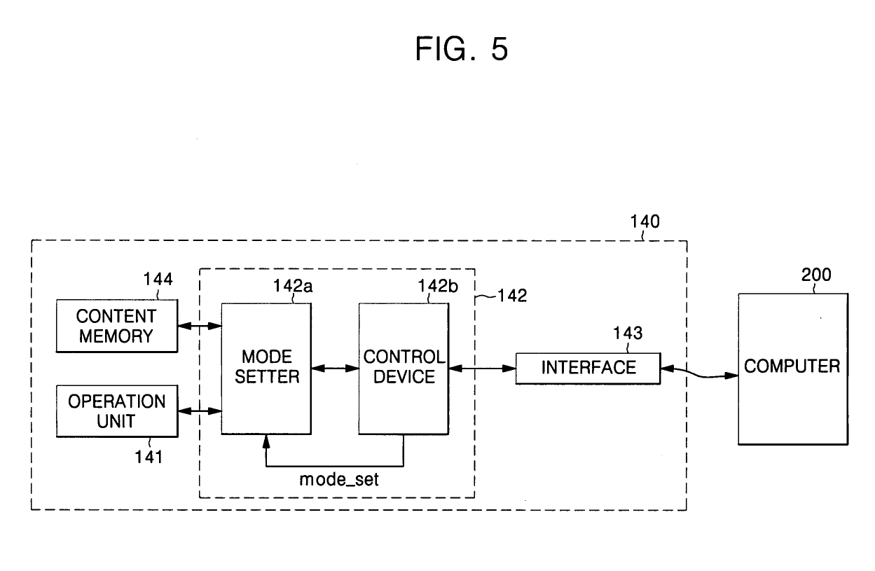

FIG. 5 is a block diagram of a second exemplary embodiment of a computer peripheral device containing data in accordance with the present invention.

A screensaver is stored in a content memory 144 formed of a readable/writable flash memory so that the screensaver can be upgraded.

An operation unit 141, a mode setter 142a, and an interface 143 have functions similar to the operation unit 111, the mode setter 112b, and the interface 113 shown in FIG. 2.

A controller 142 is comprised of a mode setter 142a and a control device 142b. The control device 142b outputs the mode selection signal mode_set for setting the mode setter 142a to the content mode when the peripheral device is initially operated in the basic function mode on or after supply of power, i.e., when power is supplied to a computer 200 or when the peripheral device 140 is connected to the computer 200. And, the control device 142b determines whether the computer 200 is connected to the Internet. When the computer 200 is connected to the Internet, the control device 142b determines whether a content screensaver from a designated Internet website is a newer version than a content screensaver stored in the memory 144. When a newer version is available from the designated Internet website, the control device 142b deletes the content screensaver stored in the memory 144 and performs an upgrade operation for storing the newer version of content screensaver.

In addition, the control device 142b determines whether the content screensaver is installed in the computer 200, installs the content screensaver in the content memory 144 when the screensaver is not installed or an older version is installed, and replaces the preexisting screensaver with the content screensaver.

Since the computer peripheral device containing contents shown in FIG. 5 utilizes a screensaver function usually adapted to a graphic user interface (GUI)-based operating system such as Windows, Mac OS, and X Windows of Linux or Unix Systems, which are widely used nowadays, there is no need for a separate driving program for executing contents. Besides, the screensaver based on this invention cannot be terminated before a screensaver program is finished. In other words, unless computer notices termination of screensaver execution, content memory mode is not changed to operation mode. With this feature, contents of screensaver can be copy-protected or can be used for advertisement purpose.

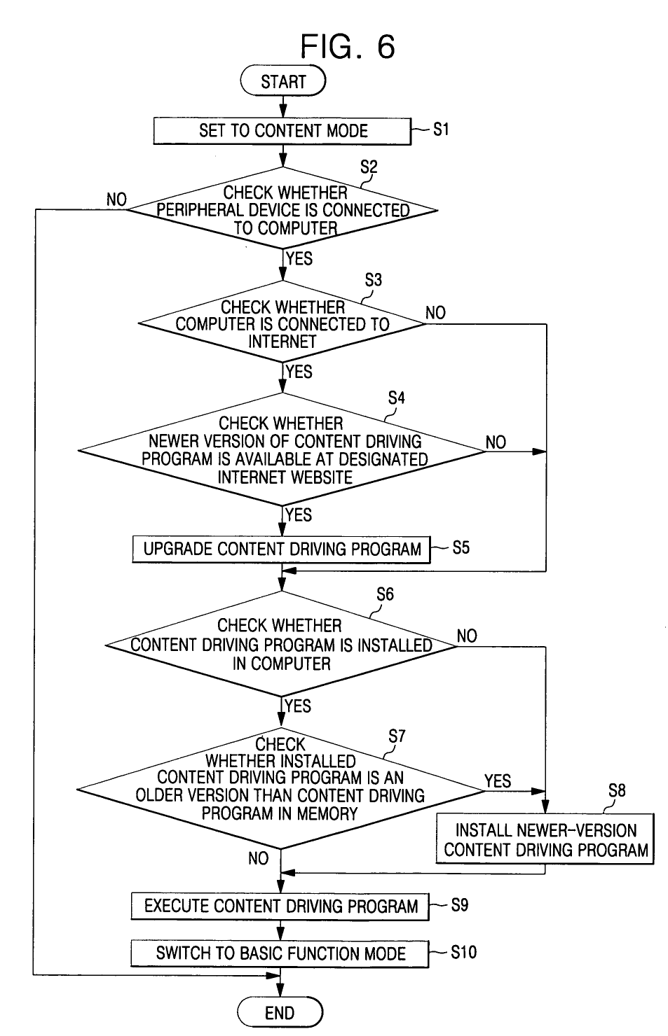

FIG. 6 is a flowchart showing a first exemplary embodiment of a content output method using a computer peripheral device containing contents according to the present invention.

Describing the flowchart of FIG. 6 with reference to FIG. 2, when power is supplied to a computer peripheral device 110 or the peripheral device 110 is initially operated in a basic function mode after power is supplied, a control device 112b outputs a mode selection signal mode_set to set a mode setter 112a to a content mode (S1).

Checking whether the computer peripheral device 110 containing contents is connected to the computer 200 is determined (S2), when it is determined that the peripheral device 110 is not connected to the computer 200, operation of the peripheral device 110 is terminated. When it is determined that the peripheral device 110 is connected to the computer 200, it is determined whether the computer 200 is connected to the Internet (S3). When the computer 200 is connected to the Internet, it is determined whether a newer version of a content driving program is available at a designated Internet website (S4). When a newer version is available, a content driving program stored in a content memory is deleted and upgraded to the newer version (S5). Here, when the computer is not connected to the Internet, or no newer version of the content driving program is available at the designated Internet website, the upgrade operation is omitted.

The control device 112b determines whether the content driving program in the content memory 114 is installed in the computer 200 (S6). When the content driving program is installed, the control device 112b checks whether the installed version is older than the version stored in the content memory 114 (S7). When the installed content driving program is an older version than the content driving program in the content memory 114, the control device 112b installs the content driving program stored in the memory 114 in the computer 200 (S8). Also, when it is determined in S6 that the content driving program in the content memory 114 is not installed in the computer 200, the control device 112b installs the content driving program stored in the memory 114 in the computer 200 (S8).

When the content driving program is installed in the computer 200, the control device 112b executes the control driving program (S9), and receives a mode conversion signal generated on completion of the content driving program. The control device then outputs a mode selection signal mode_set to the mode setter 112a to switch from the content mode to the basic function mode (S10).

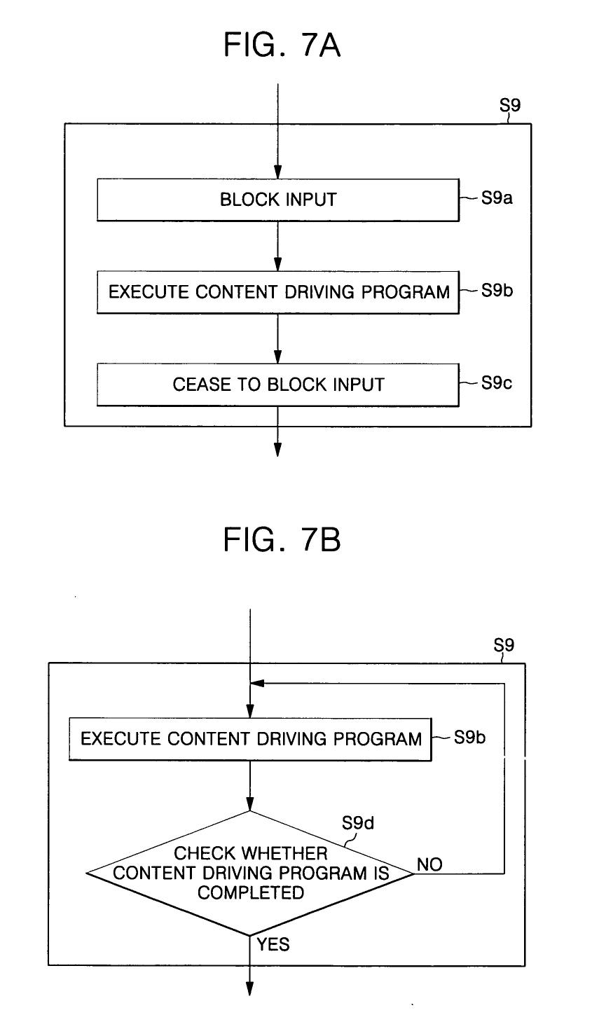

FIGS. 7A and 7B are flowcharts showing a step S9 of executing a content driving program in the method shown in FIG. 6.

As can be seen from FIG. 7A, before executing the content program (S9B), the control device 112b blocks input to all peripheral devices connected to the computer 200 to prevent the user from stopping the content driving program (S9A), and stops the input blocking when execution of the content driving program is finished (9C).

As can be seen from FIG. 7B, showing another method of preventing the user from stopping the content driving program, when the content driving program is abnormally terminated by the user before completion, the control device re-executes the content driving program (S9B) without switching to the basic function mode (S9D).

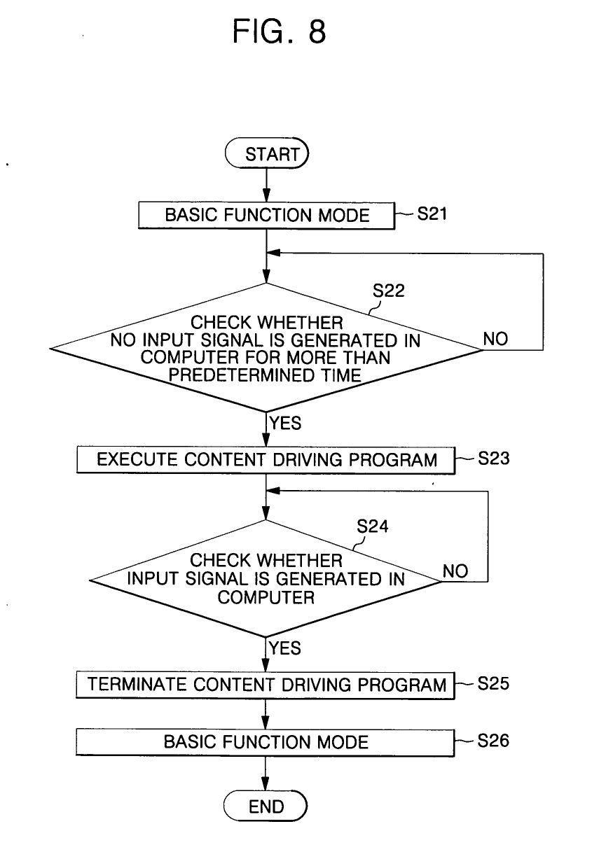

FIG. 8 is a flowchart showing a second exemplary embodiment of a content output method using a computer peripheral device containing contents.

When an input signal is not generated in the operation unit 111 of the peripheral device 110 for more than a predetermined time (S22) while the peripheral device 110 operates in the basic function mode (S21), the control device 112b executes the content driving program in the computer 200 (S23).

When an input signal is generated from the operation unit 111 during execution of the content driving program, the control device 112b orders the computer 200 to terminate the content driving program (S25) and return the peripheral device to the basic function mode (S26).

While this invention has been described with reference to exemplary embodiments thereof, it will be clear to those of ordinary skill in the art that various modifications can be made to the described embodiments within the spirit and the scope of the invention set forth in the appended claims.

Accordingly, the computer peripheral device containing contents and the content output method using the same in accordance with the present invention automatically execute the content driving program stored in the memory when the peripheral device is initially operated in the basic function mode on or after supply of power, i.e., when power is supplied to the computer or when the peripheral device is connected to the computer while power is supplied. The peripheral device also blocks communication completely or partially with the computer during execution of the content driving program to prevent the content driving program from being terminated, or enable the basic function of the peripheral device to be used only when the content driving program is finished so that the contents are executed without fail. When there is no input through the peripheral device for a predetermined time, the content driving program is executed to increase efficiency of the contents.

In addition, the computer peripheral device containing contents and the content output method using the same in accordance with the present invention convert a computer screensaver into a content screensaver using the peripheral device containing the content screensaver stored in memory, so that a user can conveniently execute contents.

What is claimed is:

1. A computer peripheral device containing contents, the device comprising:
a memory in which contents and a program for driving the contents are previously stored, the memory outputting the contents and/or the content driving program in a content mode;
an operation unit for performing a basic function of the computer peripheral device in a basic function mode;
a controller setting the peripheral device to the content mode when a basic function of the peripheral device is initially performed on or after supply of power to execute the content driving program in a connected computer, and receiving a mode conversion signal generated on completion of the content driving program to switch from the content mode to the basic function mode for operation of the operation unit; and
an interface for converting a signal output from the controller in a manner designated by the connected computer to output the converted signal.

2. The computer peripheral device containing contents according to claim 1, wherein the operation unit generates an input signal in response to an input applied from the exterior to output the input signal to the controller when the computer peripheral device is an input device, receives an output signal from the controller to output the output signal in a designated manner when the computer peripheral device is an output device, and stores data in response to a control signal applied from the controller or outputs stored data when the computer peripheral device is a storage device.

3. The computer peripheral device containing contents according to claim 1, wherein the controller comprises:
a mode setter for selecting one of the content mode and the basic function mode in response to a mode selection signal; and
a control device outputting the mode selection signal to the mode setter in response to the mode conversion signal when a basic function of the peripheral device is initially performed on or after supply of power, determining whether a newer version of the content driving program stored in the memory is available at a designated Internet website when the computer is connected to the Internet and storing the newer version when available, installing the newer-version content driving program in the content memory when the content driving program is not installed or when an older version of the content driving program is installed, and executing the content driving program.

4. The computer peripheral device containing contents according to claim 3, wherein the control device blocks, or partially blocks, input to all peripheral devices connected to the computer before performing the content driving program in order to prevent interruption of the content driving program by a user when the peripheral device is initially used in the basic function mode on or after the supply of power, and ceases the input blocking when the content driving program is completed.

5. The computer peripheral device containing contents according to claim 3, wherein the control device is not switched to the basic function mode when the content driving program is interrupted by a user before normal completion, in the case of the peripheral device being set to the content mode on operation of the initial basic function on or after the supply of power.

6. The computer peripheral device containing contents according to claim 1, wherein the controller is switched to the content mode to execute the content driving program in the computer when an input of a user is not detected by the computer for more than a predetermined time in the basic function mode, and instantly switched to the basic function mode when an input of a user is detected by the computer.

7. A computer peripheral device containing contents, the device comprising:
a memory in which a content screen saver is previously stored, the memory outputting the content screensaver in a content mode;
an operation unit for performing a basic function of the computer peripheral device in a basic function mode;
a controller setting the peripheral device to the content mode when a basic function of the peripheral device is initially performed on or after supply of power to determine whether the content screensaver is installed in a connected computer, installing the content screensaver in the memory when the screensaver is not installed, converting a preexisting screensaver set in the computer into the content screensaver, and receiving a content screensaver installation termination signal from the computer to switch from the content mode to the basic function mode for operation of the operation unit; and
an interface for converting a signal output from the controller in a manner designated by the connected computer to output the converted signal.

8. The computer peripheral device containing contents according to claim 7, wherein the operation unit generates an input signal in response to an input applied from the exterior to output the input signal to the controller when the computer peripheral device is an input device, receives an output signal from the controller to output the output signal in a designated manner when the computer peripheral device is an output device, and stores data in response to a control signal applied from the controller or outputs stored data when the computer peripheral device is a storage device.

9. The computer peripheral device containing contents according to claim 7, wherein the controller comprises:
a mode setter for selecting one of the content mode and the basic function mode in response to a mode selection signal; and
a control device outputting the mode selection signal to the mode setter in response to the content screensaver installation termination signal when a basic function of the peripheral device is initially performed on or after supply of power, determining whether a newer version of the content screensaver stored in the memory is available at a designated Internet website when the computer is connected to the Internet and storing the newer version when available, installing the newer-version content screensaver in the content memory when the content screensaver is not installed or when an older version of the content screensaver is installed, and executing the content screensaver.

10. A content output method using a computer peripheral device containing contents, the method comprising:
a) a content mode step of determining whether the peripheral device is connected to a computer when the peripheral device is initially operated in a basic function mode on or after supply of power to terminate the basic function mode if the peripheral device is not connected to the computer, and set the peripheral device to a content mode if the peripheral device is connected to the computer;
b) an upgrade step of determining whether a newer version of a content driving program previously stored in a memory is available on the Internet when the computer is connected to the Internet and downloading and storing the newer version in the memory when available;
c) a program installation step of determining whether the new-version content driving program stored in the memory is installed in the computer and installing the new-version content driving program when no content driving program is installed or when the installed content driving program is an older version than the content driving program stored in the memory;
d) a first content output step of executing the content driving program to output the contents when the content driving program is installed; and
e) a basic function mode step of setting the computer peripheral device to the basic function mode to perform a basic function.

11. The content output method according to claim 10, wherein step d) comprises the sub-steps of:
blocking input from all peripheral devices connected to the computer before executing the content driving program to prevent a user from interrupting the content driving program; and
ceasing to block input from the peripheral devices upon completion of the content driving program.

12. The content output method according to claim 10, wherein in step d), the peripheral device does not switch to the basic function mode when the content driving program is interrupted by a user before normal completion.

13. The content output method according to claim 10, wherein step e) comprises:
a step of determining whether an input is applied to the connected computer;
a second content output step of executing the content driving program to output the contents when there is no input for more than a predetermined time; and
a step of instantly returning to the basic function mode when an input is applied from the exterior.
